(19) United States
(12) Patent Application Publication
(10) Pub. No.: US 2026/0016578 A1
(43) Pub. Date: Jan. 15, 2026

(54) MACHINE SENSOR CALIBRATION SYSTEM

(71) Applicant: Caterpillar Inc., Peoria, IL (US)

(72) Inventors: Karl Kirsch, Chillicothe, IL (US); Jeffrey Kent Berry, Yorkville, IL (US)

(73) Assignee: Caterpillar Inc., Peoria, IL (US)

(21) Appl. No.: 18/771,329

(22) Filed: Jul. 12, 2024

(51) Int. Cl. G01S 7/497

(52) U.S. Cl. CPC G01S 7/497

(57) ABSTRACT

A target machine may have a target sensor, such as a LiDAR sensor, a radar sensor, a camera, or other sensor. The target sensor of the target machine may be calibrated based on sensor data captured by a sensor of a different observing machine, such as a LiDAR sensor on the observing machine that captures data indicative of positions of the target sensor and the target machine. The target sensor of the target machine may also or alternatively be calibrated based on sensor data captured directly by the target sensor, for instance based on location of marker points on the target machine itself that are indicated by the sensor data captured directly by the target sensor.

### TECHNICAL FIELD

The present disclosure relates to sensors of a machine and, more particularly, to using sensor data to calibrate a sensor of a machine.

### BACKGROUND

Machines, such as wheel loaders, haul trucks, and other work machines, may perform various operations at worksites or other environments. As an example, a wheel loader may operate to transport material around a worksite.

Such machines may have one or more sensors that may be used to detect objects around the machines, to determine paths for autonomous travel of the machines, and/or to perform other operations. As an example, a machine may have a sensor that is configured to detect external objects, so that a collision avoidance system may alert a machine operator if sensor data from the sensor indicates that the machine is at risk of colliding with a detected external object. As another example, a machine may have a sensor that may detect features of an environment around the machine, so that a computing system of the machine may autonomously direct driving operations and/or other machine operations based on sensor data from the sensor. Such sensors may be calibrated so that captured sensor data may be accurate and/or interpreted properly.

Various systems have been developed in the past that relate to calibration and usage of machine sensors. For example, U.S. Pat. No. 10,531,004 to Wheeler et al. (hereinafter “Wheeler”) describes a system in which multiple sensors mounted on a vehicle may each capture data about the same external object, such that a transform between the respectively captured data can be determined and used to calibrate the sensors with respect to each other. For instance, Wheeler indicates that a LiDAR sensor and a camera that are both mounted on the same vehicle may capture data indicative of a checkerboard pattern located at an external position away from the vehicle, such that positions of the checkerboard pattern indicated by data separately captured by the LiDAR and the camera may be used to determine a LiDAR-to-camera transform. The determined transform may be used to calibrate the sensors with respect to each other, for instance to determine how data captured by both sensors are correlated. However, while the system described by Wheeler may use sensor data captured by multiple sensors on the same vehicle to calibrate the sensors, the system described by Wheeler may have limited abilities to perform sensor calibration based on sensor data captured by a single sensor and/or based on sensor data indicative of the body of the vehicle on which a sensor is mounted.

Examples of the present disclosure are directed to overcoming the deficiencies noted above.

### SUMMARY

According to a first aspect of the present disclosure, a method is executed by a computing system including a processor. The method includes obtaining observed sensor data captured by an observing sensor of an observing machine. The observing machine is different from a target machine, the observing sensor is different from a target sensor of the target machine, and the observed sensor data is captured based on an observed reference frame. The method includes determining first coordinates, in the observed reference frame, of the target sensor based on the observed sensor data. The method includes determining second coordinates, in the observed reference frame, of an origin point of a target machine reference frame associated with the target machine. The method includes determining data difference between the observed reference frame and the target machine reference frame. The method includes determining a transformation, based on the first coordinates, the second coordinates, and the difference. The transformation indicates third coordinates of the target sensor in the target machine reference frame. The method includes generating calibration data, for the target sensor, indicating the transformation.

According to a second aspect of the present disclosure, a system includes a target machine and an observing machine. The target machine includes a first controller and a target sensor. The observing machine includes a second controller and an observing sensor. The second controller is configured to obtain observed sensor data captured by the observing sensor based on an observed reference frame. The second controller is configured to determine, based on the observed sensor data, a first location and a first orientation of the target sensor within the observed reference frame. The second controller is configured to determine, based on the observed sensor data, a second location and a second orientation, within the observed reference frame, of a target machine reference frame associated with the target machine. The second controller is configured to determine differences between the observed reference frame and the target machine reference frame. The second controller is configured to determine, based on the differences and the first location, the first orientation, the second location, and the second orientation within the observed reference frame, transformation data indicating a third location and a third orientation of the target sensor within the target machine reference frame. The second controller is configured to generate calibration data, for the target sensor, indicating the transformation data. The first controller is configured to use the calibration to interpret sensor data captured by the target sensor.

According to a third aspect of the present disclosure, a controller of a machine includes one or more processors and memory. The memory stores computer-executable instructions that, when executed by the one or more processors, cause the one or more processors to perform operations. The operations include obtaining sensor data captured by a sensor of the machine based on a sensor reference frame. The operations include determining, based on the sensor data, locations of one or more marker points on the machine. The operations include determining, based on the sensor data, a first location and a first orientation of a machine reference frame associated with the machine, relative to the locations of the one or more marker points. The operations include determining, based on the sensor data, a second location and a second orientation of the sensor, relative to the locations of the one or more marker points. The operations include determining, based on the first location, the first orientation, the second location, and the second orientation relative to the locations of the one or more marker points, transformation data indicating a third location and a third orientation of the sensor within the machine reference frame. The operations include generating calibration data, for the sensor, indicating the transformation data.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 shows an example of a calibration system in which a target sensor of a target machine may be calibrated based on observed sensor data captured via an observing sensor of an observing machine.

FIG. 2 shows an example of a self-calibration system in which a target sensor of a target machine may be calibrated based on sensor data captured by the target sensor.

FIG. 3 is a flowchart illustrating an example process for determining calibration data for a target sensor on a target machine, based on observed sensor data captured by an observing sensor of an observing machine.

FIG. 4 is a flowchart illustrating an example process for self-calibrating a target sensor on a target machine, based on sensor data captured by the target sensor.

FIG. 5 is a flowchart illustrating an example process for detecting a loss of calibration of a target sensor on a target machine, based on sensor data captured by the target sensor.

FIG. 6 shows an example system architecture for a computing system that executes one or more elements described in the present disclosure.

### DETAILED DESCRIPTION

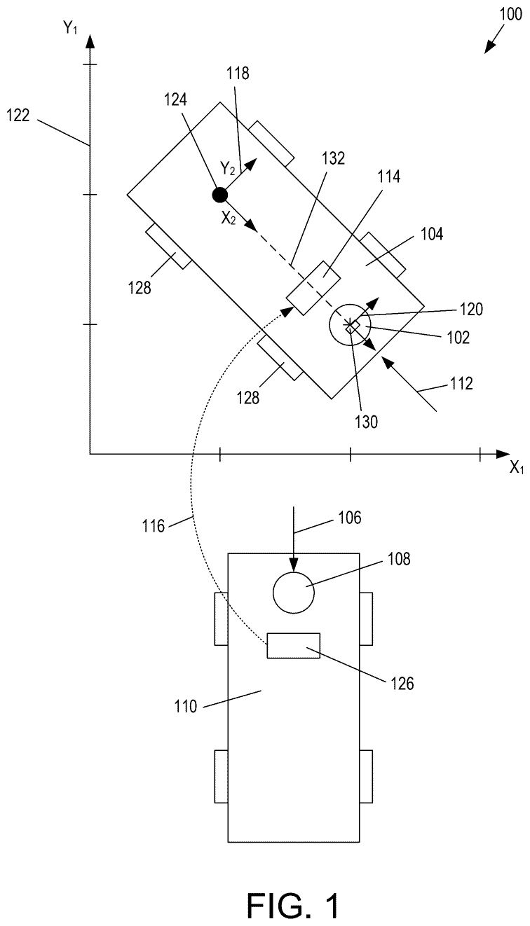

FIG. 1 shows an example of a calibration system 100 in which a target sensor 102 of a target machine 104 may be calibrated based on observed sensor data 106 captured via an observing sensor 108 of an observing machine 110. The observing machine 110 may be different from, and separate from, the target machine 104. The target sensor 102 and the observing sensor 108 may accordingly be associated with different machines, such that the target sensor 102 may be calibrated based on external observations as described further below.

The target machine 104 and the observing machine 110 may be commercial or work machines, such as vehicles, pieces of heavy machinery, pieces of industrial equipment, or other types of machines. For example, the target machine 104 or the observing machine 110 may be a mining machine, earth-moving machine, backhoe, scraper, dozer, loader (e.g., large wheel loader, track-type loader, etc.), shovel, truck (e.g., mining truck, haul truck, on-highway truck, off-highway truck, articulated truck, tanker, etc.), a crane, a pipe layer, a paver, a compactor, a tractor, farming equipment, or any other type of machine. The target machine 104 and the observing machine 110 may be the same type of machine, or may be different types of machines.

In some examples, the target machine 104 and the observing machine 110 may be mobile machines or vehicles that may drive or otherwise move around an environment. In other examples, the target machine 104 and the observing machine 110 may be stationary machines that operate while stationary at fixed locations. In some examples, one of the target machine 104 and the observing machine 110 may be a mobile machine, while the other one of the target machine 104 and the observing machine 110 may be a stationary machine.

The target machine 104 and the observing machine 110 may, in some examples, operate at a worksite, such as a mine site, a quarry, a construction site, a farm, or any other type of worksite or work environment. In other examples, the target machine 104 and the observing machine 110 may operate at any other environment.

The target machine 104 may be a manually-operated staffed machine, a semi-autonomous machine, or an autonomous machine. The observing machine 110 may similarly be a manually-operated staffed machine, a semi-autonomous machine, or an autonomous machine.

In examples in which target machine 104 or the observing machine 110 is a staffed machine or a semi-autonomous machine, a human operator or driver may operate, control, or direct some or all of the functions of the machine. In examples in which the target machine 104 or the observing machine 110 is autonomous or semi-autonomous, functions of the machine, such as steering, speed adjustments, work tool positioning and movement, and/or other functions, may be fully or partially controlled, automatically or semi-automatically, by on-board and/or off-board controllers or other computing devices associated with the machine. Such autonomous or semi-autonomous operations of a machine may be based at least in part on sensor data captured by one or more sensors of the machine. For instance, autonomous or semi-autonomous operations of the target machine 104 may be determined, at least in part, based on sensor data 112 captured by the target sensor 102 and/or based on sensor data captured by one or more other sensors of the target machine 104.

The target sensor 102 may capture sensor data 112 about a surrounding environment around the target machine 104. For example, the target sensor 102 may be a radar sensor, a camera, a Light Detection and Ranging (LiDAR) sensor, or other type of sensor. For example, the sensor data 112 may be LiDAR data, radar data, image data, or other data that indicates the presence of one or more objects or other features within a surrounding environment in front of and/or around the target machine 104. In some examples, the target sensor 102 may be associated with a sensor jig, such as a housing that covers or extends around one or more portions of the target sensor 102.

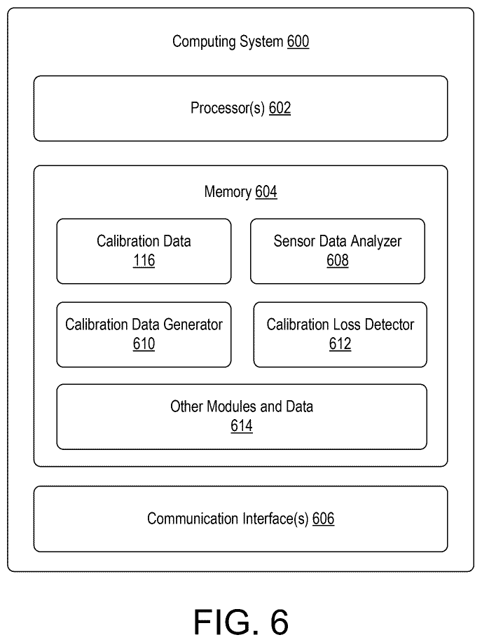

The sensor data 112 captured by the target sensor 102 may be provided to, used by, and/or interpreted by, a controller 114 of the target machine 104. The controller 114 may be an electronic control module (ECM) or other on-board computing system of the target machine 104. FIG. 6, discussed further below, describes an example system architecture for the controller 114.

The controller 114 may be configured to use the sensor data 112 captured by the target sensor 102. For example, the controller 114 may be configured to use the sensor data 112 captured by the target sensor 102 to autonomously determine a travel path for the target machine 104 that avoids detected objects and/or follows detected roads or paths, to alert an operator of the target machine 104 when the target machine 104 is at risk of colliding with detected objects, to denote the locations of detected objects on a map of a worksite or other environment, and/or for any other purpose.

The controller 114 of the target machine 104 may be configured to interpret sensor data 112 captured by the target sensor 102 based on calibration data 116. The calibration data 116 may define a transform that indicates coordinates of a location of the target sensor 102 on the target machine 104, and/or an orientation of the target sensor 102, with respect to a target machine reference frame 118 associated with the target machine 104. As discussed further below, the target machine reference frame 118 may be defined to have axes oriented with respect to the target machine 104 overall, such as axes oriented based on the dimensions and/or shape of the target machine 104. However, the target sensor 102 may be mounted or located at any position on the target machine 104, and/or may be rotated or oriented relative to the target machine reference frame 118 such that an internal sensor reference frame 120 used by the target sensor 102 may be different from the target machine reference frame 118. In some examples, a sensor jig, such as a housing around the target sensor 102, may be oriented based on a sensor jig reference frame that may differ from one or more of the other reference frames discussed herein. For instance, the orientation of an outer sensor housing around the target sensor 102, and thus the orientation of the sensor jig reference frame associated with the sensor housing, may differ from the orientation of the internal sensor reference frame 120 that the target sensor 102 uses to capture sensor data. However, as described herein, the transform defined by the calibration data 116 may indicate the position and/or orientation of the target sensor 102 and/or its internal sensor reference frame 120 relative to the target machine reference frame 118, and thereby indicate extrinsic calibration values for the target sensor 102.

For example, the transform defined by the calibration data 116 may include translation data that identifies coordinates within the target machine reference frame 118, such as x, y, and z coordinates, that indicate the location of the target sensor 102 on the target machine 104. The transform defined by the calibration data 116 may also include rotational data that indicates an orientation of the target sensor 102 with respect to the target machine reference frame 118. For instance, the rotational data may indicate roll, pitch, and/or yaw values that indicate an orientation, relative to the target machine reference frame 118, of the target sensor 102 and/or the internal sensor reference frame 120 used by the target sensor 102.

The controller 114 may accordingly use the transform defined by the calibration data 116 to interpret sensor data captured by the target sensor 102 based on the target machine reference frame 118 instead of, or in addition to, the internal sensor reference frame 120. For example, the target sensor 102 may natively capture sensor data based on an internal sensor reference frame 120. However, based on translation data and/or rotational data in the calibration data 116 that indicates the position and/or orientation of the target sensor 102 within the target machine reference frame 118, the controller 114 may transform the captured sensor data into transformed sensor data that is expressed based on the target machine reference frame 118. Accordingly, the transformed sensor data, determined based on the calibration data 116, may be aligned with the target machine reference frame 118. The controller 114 may thus use the transformed sensor data, determined based on the calibration data 116, to more accurately detect positions of external objects or features, such as other machines, obstacles, environmental features, pedestrians, and/or other objects, relative to the shape, location, and trajectory of the target machine 104.

As described herein, the calibration data 116 may be determined based on observed sensor data 106 captured by the observing sensor 108 of the observing machine 110. The observing sensor 108 may be a LiDAR sensor, radar sensor, camera, or other type of sensor of the observing machine 110 that captures observed sensor data 106 associated with the target sensor 102 and/or the target machine 104. The observed sensor data 106 may, for instance, indicate shapes, orientations, and/or locations of the target sensor 102 and/or the target machine 104.

As an example, the target machine 104 and the observing machine 110 may both be present at a worksite or other environment. The observing sensor 108 may be a LiDAR sensor of the observing machine 110 that captures LiDAR data, such as point cloud data, indicative of an environment near and/or around the observing machine 110. Becuase the target machine 104 may be within the environment that is near and/or around the observing machine 110, the observed sensor data 106 captured by the observing sensor 108 of the observing machine 110 may indicate shapes, orientations, and/or locations of the target sensor 102 and the target machine 104. For instance, the observed sensor data 106 may be LiDAR data, such point cloud data, indicating three-dimensional coordinates of points on the target sensor 102 and other points on the exterior of the target machine 104.

The observed sensor data 106 may indicate coordinates of points on the target sensor 102 and the target machine 104 within an observed reference frame 122 used by the observing sensor 108 and/or other elements of the observing machine 110. The observed reference frame 122 may be different than the target machine reference frame 118 and/or an internal sensor reference frame 120 used by the target sensor 102. For example, as shown in FIG. 1, the observed reference frame 122 may be defined by axes of a first coordinate system, such as an X₁ axis and a Y₁ axis. However, as also shown in FIG. 1, the target machine reference frame 118 may be defined by axes of a second coordinate system, such as an X₂ axis and a Y₂ axis, that may be oriented along different directions relative to the axes of the observed reference frame 122. For instance, if the target machine 104 and the observing machine 110 are oriented along different directions as shown in FIG. 1, the target machine reference frame 118 associated with the target machine 104 may be different from the observed reference frame 122 associated with the observing machine 110.

In other examples or situations, the target machine reference frame 118 and the observed reference frame 122 may have X and Y axes that are oriented in the same directions, for instance if the target machine 104 and the observing machine 110 are oriented along the same direction. However, the target machine reference frame 118 and the observed reference frame 122 may have different origin points. As discussed further below, the target machine reference frame 118 may have an origin point 124 that is located at a particular position on or within the target machine 104, such as a position that is halfway between back wheels of the target machine 104. The observed reference frame 122 may have the same or a different origin point, such as an origin point at the location of the observing sensor 108, at a location midway between back wheels of the observing machine 110, or any other location. For example, FIG. 1 depicts the origin point of the observed reference frame 122 being positioned away from both the target machine 104 and the observing machine 110, but the origin point of the observed reference frame 122 may be at a different location.

Although the X and Y axes and/or origin points of the target machine reference frame 118 and the observed reference frame 122 may be different in some situations as shown in the top-down view of FIG. 1, the target machine reference frame 118 and the observed reference frame 122 may also have the same or different Z axes. Accordingly, positions may be expressed via three-dimensional coordinates expressed based on either or both of the target machine reference frame 118 and the observed reference frame 122.

A computing system may use the observed sensor data 106 captured by the observing sensor 108 to determine the calibration data 116. The computing system that determines the calibration data 116 may, in some examples, be an observing machine controller 126 of the observing machine 110, such as an ECM or other on-board computing device of the observing machine 110. In other examples, the observed sensor data 106 captured by the observing sensor 108 may be provided via a wired or wireless data connection to a remote computing system, such as a tablet computer, a laptop computer, a back office server, a cloud computing system, or other computing system that is separate from the target machine 104 and the observing machine 110. In these examples, the remote computing system may use the observed sensor data 106 to determine the calibration data 116. In still other examples, the observed sensor data 106 captured by the observing sensor 108 may be provided via a wired or wireless data connection to the controller 114 of the target machine 104, such that the controller 114 of the target machine 104 may use the observed sensor data 106 to determine the calibration data 116.

After the calibration data 116 has been determined, the calibration data 116 may be accessed by, and/or provided to, the controller 114 of the target machine 104. For example, if the calibration data 116 is determined by the observing machine controller 126 of the observing machine 110, the calibration data 116 may be transferred from the observing machine controller 126 to the controller 114 of the target machine 104 via a wired or wireless connection, for instance via a cellular data connection, via a wireless machine-to-machine communication system, via Ethernet cables connected to both the target machine 104 and the observing machine 110, or via other wired or wireless connections. Alternatively, the calibration data 116 determined by the observing machine controller 126 may be loaded from the observing machine controller 126 onto a memory card, USB storage device, or other removable storage device, such that the removable storage device may be transported and connected to the controller 114 of the target machine 104 in order to transfer the calibration data 116 to the controller 114. In still other examples, the calibration data 116 may be transferred from the observing machine controller 126 to a remote computing system, such as a tablet computer, laptop computer, a back office server, a cloud computing system, or another separate computing system, and the controller 114 of the target machine 104 may download or otherwise receive the calibration data 116 from the remote computing system.

The computing system that determines the calibration data 116, such as the observing machine controller 126 in some examples, may use the observed sensor data 106 to identify locations and/or orientations, relative to the observed reference frame 122, of the target sensor 102 and the target machine 104. For example, the computing system may identify sets of one or more points, within point cloud data captured by the observing sensor 108, that are respectively associated with the target sensor 102 and the target machine 104 and that indicate locations and/or orientations of the target sensor 102 and the target machine 104 within the observed reference frame 122. The computing system may, for instance, use the observed sensor data 106 to identify one or more marker points 128 on the target machine 104, and use positions of the marker points 128 to determine a shape and/or orientation of the target machine 104. The computing system may also use the observed sensor data 106 to identify one or more fiducial marker 130 on the target sensor 102, and/or other features of the target sensor 102, that indicates a location and/or orientation of the target sensor 102 relative to the shape and/or orientation of the target machine 104.

The computing system may determine the location and/or orientation of the target sensor 102, within the observed reference frame 122, based on the observed sensor data 106. For example, the computing system may evaluate the observed sensor data 106 to identify one or more fiducial markers 130 on the target sensor 102, a shape of an external housing of the target sensor 102, and/or other distinctive physical features of the target sensor 102. Based on identification of such fiducial marker 130 and/or other features associated with the target sensor 102, the computing device may determine corresponding coordinates of the target sensor 102 within the observed reference frame 122 and/or an orientation of the target sensor 102 relative to the observed reference frame 122.

As an example, the target sensor 102 may have one or more fiducial markers 130 that differentiate the target sensor 102 from other elements of the target machine 104 in the observed sensor data 106. In some examples, a fiducial marker 130 may be a sticker or other visual element on the exterior of the target sensor 102 that is more or less reflective than other elements of the target machine 104. The different reflectivity of the fiducial marker 130 may cause the fiducial marker 130 to be associated with a different signal, different measured values, and/or other different data, than other elements of the target machine 104 within LiDAR data or other types of observed sensor data 106. In other example, a fiducial marker 130 may be a sticker or other visual element on the exterior of the target sensor 102 that has a checkerboard pattern or other distinctive pattern, a distinctive QR code, distinctive text or characters, or other distinctive visual and/or physical elements that cause the fiducial marker 130 to be associated with a different signal, different measured values, and/or other different data, than other elements of the target machine 104 within LiDAR data or other types of observed sensor data 106.

Accordingly, the computing system may evaluate LiDAR data or other types of observed sensor data 106 to identify a portion of the observed sensor data 106 that has a different signal, different measured values, and/or other different data, than other portions of the observed sensor data 106, and determine that the identified portion is likely to indicate the location of a fiducial marker 130. The computing system may determine that the location of the fiducial marker 130 indicated by the observed sensor data 106 also indicates coordinates of the target sensor 102, associated with the fiducial marker 130, within the observed reference frame 122.

In some examples, a pattern, design, one or more characters, and/or other elements of the fiducial marker 130 may also indicate the orientation of the target sensor 102. For example, a fiducial marker 130 may depict one or more arrows that indicate an orientation of the target sensor 102 and/or the internal sensor reference frame 120 used by the target sensor 102. Accordingly, the computing system may use such aspects of the fiducial marker 130, indicated by observed sensor data 106, to determine the orientation of the target sensor 102 with respect to the observed reference frame 122. In other examples, the target sensor 102 may be associated with multiple fiducial markers 130 that indicate the orientation of the target sensor 102 instead of and/or in addition to the location of the target sensor 102. For instance, multiple fiducial markers 130 may be positioned on the target sensor 102 to indicate locations of different points associated with the internal sensor reference frame 120 used by the target sensor 102, such as origin point of the sensor reference frame 120, a point associated with a Y axis of the sensor reference frame 120, and a point associated with a Z axis of the sensor reference frame 120. Accordingly, the computing system may use LiDAR data to identify multiple fiducial markers 130 positioned at different points on the target sensor 102 that together indicate the location and orientation of the target sensor 102 with respect to the observed reference frame 122.

As another example, the target sensor 102 may have a distinctive physical shape or other physical and/or visual characteristics that allow the computing system to identify the target sensor 102 within observed sensor data 106, instead of or in addition to the use of fiducial markers 130. As a non-limiting example, the target sensor 102 may be a LiDAR sensor of the target machine 104 that has a cylindrical shape and that extends vertically from and above an exterior portion of the target machine 104. Accordingly, the computing system may evaluate the observed sensor data 106, such as LiDAR point cloud data, to identify a portion of the point cloud data that corresponds with a cylindrical shape having an axis that is oriented substantially vertically. The computing system may determine that the identified portion of the point cloud data, indicative of the cylindrical shape having the axis that is oriented substantially vertically, is associated with the target sensor 102 and indicates the location and/or orientation of the target sensor 102 within the observed reference frame 122. Similarly, the computing system may identify multiple points in LiDAR data that associated with the target sensor 102, such as points indicative of the location and/or orientation of the target sensor 102, instead of or in addition to identifying one or more fiducial markers 130 on the target sensor 102. The computing system may use the locations of such identified points and/or identified fiducial markers 130, associated with the target sensor 102, to determine corresponding coordinates within the observed reference frame 122 that are indicative of the location of the target sensor 102 and/or the origin point of the sensor reference frame 120 used by the target sensor 102, orientations of axes of the sensor frame relative to points of the target sensor 102 and/or the observed reference frame 122, and/or other information.

Accordingly, as discussed above, the computing system may use the observed sensor data 106 to determine, based on identification of one or more fiducial markers 130 on the target sensor 102 and/or other points associated with the target sensor 102, the location and/or orientation of the target sensor 102 with respect to the observed reference frame 122. The computing system may similarly use the observed sensor data 106 to identify points associated with the target machine 104, such as points on a frame of the target machine 104 and/or other components of the target machine 104, that indicate the shape and/or orientation of the target machine 104 with respect to the observed reference frame 122. As described herein, using the observed sensor data 106 to determine the shape and/or orientation of the target machine 104 may allow the computing system to determine the position and/or orientation of the target sensor 102, relative to the shape and/or orientation of the target machine 104 upon which the target sensor 102 is mounted.

The computing system may determine the shape and/or orientation of the target machine 104, with respect to the observed reference frame 122, based on identification of one or more marker points 128 indicated by the observed sensor data 106. The marker points 128 may be points on the exterior of the target machine 104 that may be indicative of the shape and/or current orientation of the target machine 104. As an example, the marker points 128 may be associated with wheels, tracks, or other traction components of the target machine 104, such as points corresponding to circular shapes of wheel hubs or tires of the target machine 104 or shapes of tracks of the target machine 104. As another example, the marker points 128 may be points corresponding to corners of a frame or housing on the exterior of the target machine 104. As yet other examples, the marker points 128 may be points associated with any other distinctive physical or visual features on the exterior of the target machine 104, such as points associated with headlights, brake lights, turn indicator lights, other lights, mirrors, logos, protruding equipment, work tools, and/or other elements or features of the target machine 104.

As a non-limiting example, the marker points 128 may associated with wheels of the target machine 104, as shown in FIG. 1. The computing system may evaluate the observed sensor data 106, such as LiDAR point cloud data, to identify locations and/or orientations of wheels of the target machine 104. For example, the computing system may be configured to identify points in LiDAR point cloud data that are arranged in circles and are likely to be associated with the shapes of wheel hubs, tires, or other components of wheels. The computing system may also use the LiDAR point cloud data to determine coordinates and/or orientations, with respect to the observed reference frame 122, of the identified wheels of the target machine 104.

In other examples, the marker points 128 on the target machine 104 may be indicated by fiducial markers 130 positioned at those marker points 128. In these examples, the fiducial markers 130 associated with the marker points 128 may be different from any fiducial markers 130 associated with the target sensor 102, for instance by having different patterns or being associated with different signals or values within the observed sensor data 106, such that the computing system may distinguish the fiducial markers 130 associated with the marker points 128 from fiducial marker 130 associated with the target sensor 102. The computing system may use the fiducial markers 130 at the marker points 128 to identify, based on LiDAR point cloud data or other observed sensor data 106, coordinates of the marker points 128 within the observed reference frame 122.

The computing system may use the coordinates of the marker points 128, within the observed reference frame 122, to determine coordinates of the origin point 124 of the target machine reference frame 118 that are expressed using the observed reference frame 122. For example, the origin point 124 of the target machine reference frame 118 may be defined as a midpoint of a line that extends between two back wheels of the target machine 104. Accordingly, the computing system may identify a marker point 128 that indicates a location of a first back wheel of the target machine 104 within the observed reference frame 122. The computing system may also determine or infer a location of the other back wheel of the target machine 104 within the observed reference frame 122 relative to the location of the first back wheel, such that the computing system can determine the location of the origin point 124 that is halfway between the locations of the two back wheels.

In some examples, the observed sensor data 106 may directly indicate positions of both back wheels of the target machine 104 within the observed reference frame 122. Accordingly, in these examples the computing system may determine the position of the origin point 124 as the midpoint between the positions of the two back wheels that are directly indicated by the observed sensor data 106.

However, in other examples the observed sensor data 106 may only directly indicate the position of one back wheel of the target machine 104, while the other back wheel is on an opposite side of the target machine 104 that is not depicted or represented by the observed sensor data 106. In these examples, the computing system may use a 3D model of the target machine 104, a 3D CAD drawing of the target machine 104, schematic information about the target machine 104, and/or other predefined information about the target machine 104 to determine a known distance between the two back wheels of the target machine 104.

The computing system may also use the observed sensor data 106 to determine an orientation of the target machine 104. As an example, the computing system may use the observed sensor data 106 to identify positions of a back wheel and a front wheel on the same side of the target machine 104, and determine an orientation of a line that extends between the positions of the identified back wheel and front wheel in order to determine the orientation of the target machine 104. As another example, the computing system may use the observed sensor data 106 to identify points along a side surface of the target machine 104, and to in turn identify an orientation of a plane spanning the side surface of the target machine 104 that indicates the orientation of the target machine 104.

Based on determining the orientation of the target machine 104 machine and the location of a first back wheel of the target machine 104 indicated by the observed sensor data 106, the computing system may infer the location of a second back wheel of the target machine 104. For example, the computing system may determine, based on predefined information, how far a second back wheel is expected to be spaced apart from a location of the first back wheel indicated, and use that information to infer the location of the second back wheel relative to the location of the first back wheel indicated by the observed sensor data 106. The computing system may also, or alternately, use predefined information to determine an expected diameter of a circular feature of the first back wheel, such as an expected rim diameter. The computing system may accordingly use points in the observed sensor data 106 that correspond to the circular feature of the first back wheel to scale a defined distance between both back wheels based on an observed diameter of the circular feature relative to the predefined diameter of the circular feature, and infer the location of the second back wheel based at least in part on the scaled distance. In these examples, the computing system may accordingly determine the position of the origin point 124 as the midpoint between a first position of the first back wheel directly indicated by the observed sensor data 106 and a second position of the second back wheel that has been inferred from the observed sensor data 106 and/or predefined information about the target machine 104.

Overall, the computing system may use detection of one or more marker points 128, based on the observed sensor data 106, to determine the location of the origin point 124 of the target machine reference frame 118. As discussed above, in some examples the origin point 124 of the target machine reference frame 118 may be a midpoint between two back wheels of the target machine 104. However, in other examples the origin point 124 of the target machine reference frame 118 may be defined as any other point.

The computing system may use coordinates of one or more marker points 128, expressed based on the observed reference frame 122, to determine coordinates of the origin point 124 that are also expressed based on the observed reference frame 122. The origin point 124 may define the origin of the target machine reference frame 118, and may thus be associated with X and Y coordinates of (0, 0) in the target machine reference frame 118. However, as a non-limiting example, the same physical location of the origin point 124 may be defined via X and Y coordinates of (1, 2), or other different coordinates, in the observed reference frame 122.

The computing system may also determine transformation data indicating differences, if any, between the target machine reference frame 118 and the observed reference frame 122. For example, the orientation of the observed reference frame 122 may be fixed relative to the observing sensor 108 and/or the observing machine 110. However, because the observing machine 110 may be aligned along a different orientation than the target machine 104 as shown in FIG. 1, the orientation of the target machine reference frame 118 may be different than the orientation of the observed reference frame 122.

The computing system may use observed sensor data 106 to determine an orientation of the target machine 104 that also indicates the orientation of the corresponding target machine reference frame 118. For instance, as discussed above, the computing system may detect differences in positions between a back wheel and a front wheel of the target machine 104 that are indicated by the observed sensor data 106 to determine the orientation of the target machine 104, use points along a side surface of the target machine 104 to define a plane oriented along a direction that corresponds with the orientation of the target machine 104, and/or otherwise use the observed sensor data 106 to determine the orientation of the target machine 104. Based on determining the orientation of the target machine 104 and/or the corresponding target machine reference frame 118, the computing system may determine transformation data indicating how much the target machine reference frame 118 is rotated relative to the observed reference frame 122, differences between the origin points of the target machine reference frame 118 and the observed reference frame 122, and/or how the target machine reference frame 118 otherwise differs from the observed reference frame 122.

As a non-limiting example, the target machine reference frame 118 may have an X₂ axis that extends from the origin point 124 towards a front of the target machine 104 along a line that is oriented based on an orientation of the target machine 104, and a Y₂ axis that extends along a line between the two back wheels of the target machine 104, as shown in FIG. 1. However, as also shown in FIG. 1, the observed reference frame 122 may have an X₁ axis and a Y₁ axis that are rotated by 45 degrees relative to the X₂ axis and a Y₂ axis of the target machine reference frame 118. The computing machine may accordingly determine transformation data indicating the 45 degree rotation of the target machine reference frame 118 relative to the observed reference frame 122. In other examples, the target machine reference frame 118 and the observed reference frame 122 may be rotated relative to each other by any other angle or amount, or otherwise differ in height, positions of origin points, or in any other attribute, and the computing system may determine transformation data indicating the differences between the target machine reference frame 118 and the observed reference frame 122.

As discussed above, the computing system may use observed sensor data 106 to determine a location and/or orientation of the target sensor 102 within the observed reference frame 122, coordinates of the origin point 124 within the observed reference frame 122, and transformation data indicating differences between the target machine reference frame 118 and the observed reference frame 122. The computing system may also use such information derived from the observed sensor data 106 to determine the calibration data 116 that defines a transform indicating the location and/or orientation of the target sensor 102 with respect to the target machine reference frame 118.

As a non-limiting example, the computing system may use observed sensor data 106 to determine that the target sensor 102 of the target machine 104 is located at X and Y coordinates of (2, 1) in the observed reference frame 122, that the origin point 124 is located at X and Y coordinates of (1, 2) in the observed reference frame 122, and that the target machine reference frame 118 is rotated by 45 degrees relative to the observed reference frame 122. Based on this data, the computing system may determine that the target sensor 102 is located at a position that is separated by a vector 132 from the origin point 124. The computing system can accordingly define the position of the target sensor 102 using coordinates of the target machine reference frame 118 relative to the origin point 124, rather than coordinates of the observed reference frame 122.

For instance, in the example shown in FIG. 1, the computing system may determine that the location of the target sensor 102 is located on the X₂ axis of the target machine reference frame 118. Accordingly, the computing system may determine that the location of the target sensor 102 is defined by X and Y coordinates of (L, 0) in the target machine reference frame 118, where L is the length of the vector 132 that separates the origin point 124 and the target sensor 102. As such, although in some examples the location of the target sensor 102 may be defined by coordinates of (2, 1) in the observed reference frame 122, the location of the target sensor 102 may be defined by coordinates of (L, 0) in the target machine reference frame 118. In other examples in which the location of the target sensor 102 is not located on the X₂ axis of the target machine reference frame 118, the location of the target sensor 102 may be defined by other X and Y coordinates within the target machine reference frame 118.

The computing system may similarly use a determination of the orientation of the target sensor 102, based on the observed sensor data 106, within the observed reference frame 122 to determine a corresponding orientation of the target sensor 102 with respect to the target machine reference frame 118. For example, although in some examples the target sensor 102 may be mounted on the target machine 104 such that an orientation of the target sensor 102 and or its internal sensor reference frame 120 aligns with an orientation of the target machine reference frame 118, in other examples the orientation of the target sensor 102 and/or its internal reference frame may be rotated relative to the target machine reference frame 118.

Accordingly, overall, the computing system may determine a transformation from the target machine reference frame 118 to the internal sensor reference frame 120 used by the target sensor 102. The transformation may be used as the calibration data 116 described herein.

A transformation may include, or be based on, of a translation of X, Y, and Z coordinates, and/or a 3D rotation of roll, pitch, and yaw values. Such a rotation may be defined using a rotation matrix. In some examples, rotation and translation data may be combined into a 4×4 transformation matrix or other matrix, symbolized by H herein. An upper 3×3 part of an H translation matrix may be the rotation matrix, and the right column of the matrix may be [X; Y; Z; 1].

To determine the transformation from the target machine reference frame 118 to the sensor reference frame 120 used by the target sensor 102, the computing system may determine multiple intermediate transformations based on the observed sensor data 106. In some examples, the transformations and intermediate transforms may include four transforms that are related using the following Equation 1:

$${H}_{DJ} = {H}_{DB} * {H}_{BS} * {H}_{SJ} . \qquad ( 1 )$$

In Equation 1, H_{DJ} may be a transform from the observed reference frame 122 (D) to a sensor jig reference frame (J). H_{DJ} may be calculated using key sensor jig points in the observed reference frame 122 (D) that are identified based on the observed sensor data 106, such as within LiDAR point cloud data captured by the observing sensor 108, along with known or predefined corresponding local coordinates in a sensor jig reference frame (J). For example, fiducial markers 130 or other points on the housing of the target sensor 102 may be identified based on the observed sensor data 106, and corresponding known coordinates of those points in the sensor jig reference frame may be determined.

In Equation 1, H_{DB} may be a transform from the observed reference frame 122 (D) to the target machine reference frame 118 (B). H_{DB} may be calculated using key machine frame points, such as marker points 128, within the observed reference frame 122 (D) and known or predetermined corresponding coordinates in the target machine reference frame 118 (B). For example, at least 3 points in the machine frame such as the front left tire center, rear left tire center, and top left front corner of a cab may be designated as marker points 128 that correspond with known fixed coordinates in the target machine reference frame 118. The computing system may identify those same points within the observed sensor data 106, such as within LiDAR point cloud data. The computing system may then use a similarity transform to calculate a 4×4 transformation matrix, or other matrix, that transforms the points in the observed reference frame 122 (P_{D}) to points in the target machine reference frame 118 (P_{B}), for instance based on the following Equation 2:

$${P}_{B} = inv ( {H}_{DB} ) * {P}_{D} . \qquad ( 2 )$$

In other examples, the computing system may solve Equation 2 using n point correspondences and least squares.

In Equation 1, H_{SJ} may be a transform from the sensor reference frame 120 (S) to the sensor jig reference frame (J). H_{SJ} may be a constant that is known or predetermined based on a design of the sensor jig or a fiducial marker 130 that connects to a housing of the target sensor 102. In some examples, a sensor jig may be absent, for instance if the target sensor 102 is not covered by an outer housing or is otherwise not associated with a sensor jig. In these examples, H_{SJ} may be an identity matrix, such as a 4×4 identity matrix, and the computing system may use the observed sensor data 106 to identify key points on the target sensor 102 within in the observed reference frame 122 (D), along with identifying known or predetermined corresponding local coordinates in the sensor reference frame 120 (S).

In Equation 1, H_{BS} may be a transform from the target machine reference frame 118 (B) to the sensor reference frame 120 (S). Accordingly, H_{BS} may be the transform that can be used as the calibration data 116 described herein. The computing system may solve for H_{BS} within Equation 1 after determining the other three transforms, H_{DJ}, H_{DB}, and H_{SJ}, such that the computing system may use H_{BS} as the calibration data 116.

For example, after the computing system has determined H_{DB} and H_{DJ} based on the observed sensor data 106, and has determined the constant H_{SJ} based on predetermined information about the sensor jig design, the computing system may determine H_{BS} based on a rewritten form of Equation 1 shown below as Equation 3:

$${H}_{BS} = inv ( {H}_{DB} ) * {H}_{DJ} * inv ( {H}_{SJ} ) . \qquad ( 3 )$$

As discussed above, H_{BS} may be a transform that indicates extrinsic calibration values for the target sensor 102. Accordingly, the computing system may use observed sensor data 106 to determine the H_{BS} transform, and indicate the H_{BS} transform within generated and/or output calibration data 116. The calibration data 116, via the H_{BS} transform, may indicate the position and/or orientation of the target sensor 102 and/or its internal sensor reference frame 120 relative to the target machine reference frame 118.

As discussed above, the controller 114 of the target machine 104 may use the calibration data 116, indicating extrinsic calibration values such as the coordinates of the position of the target sensor 102 within the target machine reference frame 118 and/or an orientation of the target sensor 102 with respect to the target machine reference frame 118, when the controller 114 interprets and/or uses sensor data 112 captured by the target sensor 102. The calibration data 116 may accordingly allow the controller 114 to determine the position and/or orientation of the target sensor 102 based on the target machine reference frame 118, relative to coordinates of other elements in the target machine reference frame 118. For instance, the calibration data 116 may allow the controller 114 to accurately interpret the position of the target sensor 102 relative to other portions of the target machine 104, and/or relative to positions of external objects, environment features, and/or other elements, that may be expressed based on coordinates in the target machine reference frame 118 and/or may be indicated in sensor data 112 captured by the target sensor 102.

The calibration data 116 may also, or alternately, be used by the controller 114 to transform sensor data 112 captured by the target sensor 102 into transformed sensor data that is expressed based on the target machine reference frame 118. The controller 114 may thus use the transformed sensor data, determined from the sensor data 112 based on the calibration data 116, for instance to detect positions of external objects or features relative to the shape, location, and trajectory of the target machine 104.

As discussed above, the target sensor 102 and the observing sensor 108 may be associated with different machines. For instance, the observing sensor 108 may be a LiDAR sensor on an observing machine 110 that is different and separate from the target machine 104 that has the target sensor 102. The observing sensor 108 on the observing machine 110 may capture observed sensor data 106 that indicates coordinates, within an observed reference frame 122 that differs from the target machine reference frame 118, of respective positions of the target sensor 102 and one or more marker points 128 of the target machine 104. A computing system, such as the observing machine controller 126 or a different computing system, may accordingly use the observed sensor data 106 captured by the observing sensor 108 to determine the calibration data 116 as described herein. The determined calibration data 116 may be provided to the controller 114 of the target machine 104, such that the controller 114 can use the calibration data 116 to interpret sensor data 112 captured by the target sensor 102.

In some examples, the observing sensor 108 of the observing machine 110 may capture observed sensor data 106 associated with the target sensor 102 and the target machine 104 from multiple angles and/or locations. Accordingly, instances of different observed sensor data 106 may be associated with different observation locations and/or different observed reference frames 122. In these examples, a computing system may use different instances of observed sensor data 106 that are associated with different observation locations and/or different observed reference frames 122 to enhance generation of calibration data 116 for the target sensor 102, for instance by verifying whether the different instances of observed sensor data 106 indicate the same location and/or orientation of the target sensor 102 within the target machine reference frame 118.

In some examples, because the target machine 104 and the observing machine 110 each have sensors, the sensors can respectively capture sensor data that may be used to generate calibration data 116 associated with the other sensor on the other machine. As an example, in some cases the machine shown in the top half of FIG. 1 may be the target machine 104, and the machine shown in the bottom half of FIG. 1 may be the observing machine 110. In these cases, the sensor on the machine shown in the bottom half of FIG. 1 may be used as the observing sensor 108 to capture observed sensor data 106 associated with the machine shown in the top half of FIG. 1, which may be used to generate calibration data 116 for the sensor of the machine shown in the top half of FIG. 1 as described above. However, at the same time or a different time, the machine shown in the top half of FIG. 1 may serve as the observing machine 110, and the machine shown in the bottom half of FIG. 1 may serve as the target machine 104. Accordingly, in such situations the sensor on the machine shown in the top half of FIG. 1 may be used as the observing sensor 108 to capture observed sensor data 106 associated with the machine shown in the bottom half of FIG. 1, which may be used to generate calibration data 116 for the sensor of the machine shown in the bottom half of FIG. 1.

Accordingly, different machines may serve as the target machine 104 and the observing machine 110 at different times and/or in different situations, such that sensors of multiple machines at a worksite or other environment may be calibrated via corresponding calibration data 116 determined based on observing sensor 108 captured by sensors of one or more other machines at the worksite or other environment. In some examples, the sensors of the different machines may be calibrated based on using observed sensor data 106 to identify positions and/or orientations of external checkerboard patterns, or other external elements not located on either of the machines, in addition to determining the positions and/or orientations of the sensors of the machines as described herein.

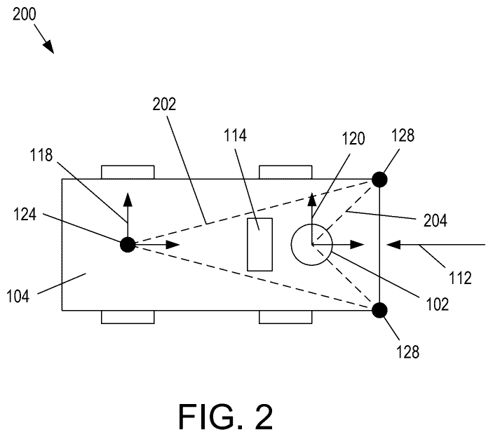

Overall, as discussed above with respect to FIG. 1, observed sensor data 106 captured by an observing sensor 108 of a different observing machine 110 may be used to determine calibration data 116 associated with a target sensor 102 of a target machine 104. However, in other examples, sensor data 112 captured by the target sensor 102 itself may be used as observed sensor data 106 during self-calibration operations for the target sensor 102. Accordingly, in such examples, the target sensor 102 of the target machine 104 may be calibrated without the use of observed sensor data 106 captured by a separate observing sensor 108 of a separate observing machine 110, as discussed further below with respect to FIG. 2.

FIG. 2 shows an example of a self-calibration system 200 in which a target sensor 102 of a target machine 104 may be calibrated based on sensor data 112 captured by the target sensor 102. Accordingly, while in some examples or situations the target sensor 102 of the target machine 104 may be calibrated using the calibration system 100 discussed above with respect to FIG. 1 in which an observing sensor 108 of a separate observing machine 110 provides observed sensor data 106 about the target machine 104, the self-calibration system 200 may allow the target sensor 102 to be calibrated based on its own captured sensor data 112 regardless of whether an observing machine 110 is proximate to the target machine 104.

In the self-calibration system 200 shown in FIG. 2, the target sensor 102 may serve as the observing sensor 108, and the sensor data 112 captured by the target sensor 102 may serve as the observed sensor data 106 that is used to generate the calibration data 116 for the target sensor 102. However, because the target sensor 102 may serve as the observing sensor 108 in the self-calibration system 200 shown in FIG. 2, the observed reference frame 122 associated with the observing sensor 108 may be the internal sensor reference frame 120 used by the target sensor 102. The sensor data 112 may be used to determine calibration data 116 defining a transform that indicates the position and/or orientation of the target sensor 102 and/or its internal sensor reference frame 120 relative to the target machine reference frame 118. The calibration data 116 may accordingly indicate extrinsic calibration values for the target sensor 102, which the controller 114 of the target machine 104 may use to interpret subsequent sensor data 112 captured by the target sensor 102.

In the self-calibration system 200, the target sensor 102 may capture sensor data 112 that indicates positions of one or more marker points 128 on the target machine 104. For example, if the target sensor 102 is a LiDAR sensor or a camera, the target sensor 102 may capture sensor data 112, such as LiDAR point cloud data or an image, that indicates positions of surrounding environmental features but that also indicates positions of one or more parts of the target machine 104 that may be used as marker points 128.

For instance, the target sensor 102 may mounted on the target machine 104 at a position and/or orientation such that at least a portion of point cloud data or an image captured by the target sensor 102 shows a portion of a front end of the target machine 104, in addition to environmental features in front of and/or around the front end of the target machine 104. A computing system, such as the controller 114 of the target machine 104 or a different computing system that processes the sensor data 112 to generate calibration data 116, may be configured to use corners of the front end of the target machine 104, or other features of the front end of the target machine 104, as marker points 128 as shown in FIG. 2. Accordingly, the computing system may use the sensor data 112 to identify elements designated as marker points 128, as well as corresponding coordinates of those marker points 128.

Based on the coordinates of the marker points 128 indicated by the observed sensor data 106, the computing system may determine coordinates of the origin point 124 of the target machine reference frame 118 and/or an orientation of the target machine reference frame 118. For instance, the computing system may be configured with predefined information 202 indicating that the origin point 124 for the target machine reference frame 118 is located at a particular location relative to the positions of left and right front corner points of the target machine 104. The predefined information 202 may also indicate an orientation of the target machine reference frame 118 relative to the left and right front corner points of the target machine 104. For example, the predefined information 202 may indicate that X, Y, and/or Z axes of the target machine reference frame 118 extend from the origin point 124 at defined directions relative to the left and right front corner points of the target machine 104. Accordingly, by using the observed sensor data 106 to identify coordinates of positions of the left and right front corner points of the target machine 104, the computing system may also use the predefined information 202 to determine or infer the coordinates of the origin point 124 of the target machine reference frame 118, and/or the orientation of the target machine reference frame 118, relative to those marker points 128.

The computing system may also use the observed sensor data 106 to determine a location and orientation of the target sensor 102 and/or the sensor reference frame 120, relative to the coordinates of the marker points 128 indicated by the observed sensor data 106. As an example, the computing system may use the observed sensor data 106 to identify coordinates of marker points 128, such as front and left front corner points of the target machine 104. The computing system may also use the coordinates of those marker points 128 to determine position information 204 indicating the location and orientation of the target sensor 102 and/or the sensor reference frame 120 relative to those marker points 128.

By determining locations and orientations of both the target machine reference frame 118 and the sensor reference frame 120, both relative to the same marker points 128 on the target machine 104 located based on the sensor data 112, the computing system may determine a transform indicating a location and orientation of the target sensor 102 and/or its sensor reference frame 120 relative to the target machine reference frame 118. As discussed above, the transform may include or be based on translation data and/or rotational data that indicates differences between the sensor reference frame 120 and the target machine reference frame 118, and may be used as the calibration data 116 for the target sensor 102.

If the controller 114 of the target machine 104 itself determined the calibration data 116 based on sensor data 112 captured by the target sensor 102, the controller 114 may use the calibration data 116 to interpret subsequent sensor data 112 captured by the target sensor 102 as described above. For example, the controller 114 may use the calibration data 116 to convert sensor data 112, captured by the target sensor 102 based on the sensor reference frame 120, into transformed sensor data that expresses information with respect to the target machine reference frame 118. The controller 114 may use such transformed sensor data, determined based on the calibration data 116, to more accurately detect positions of external objects or features, such as other machines, obstacles, environmental features, pedestrians, and/or other objects, relative to the shape, location, and trajectory of the target machine 104.

If sensor data 112 captured by the target sensor 102 is instead provided to a remote computing system, such as a tablet computer, laptop computer, back office server, or cloud computing system, that remote computing system may implement the self-calibration system 200 to determine calibration data 116 based on the provided sensor data 112. The calibration data 116 determined by the remote computing system may be downloaded or otherwise transferred to the controller 114 of the target machine 104, such that the controller 114 may use the calibration data 116 to interpret subsequent sensor data 112 captured by the target sensor 102 as discussed above.

In some examples, the self-calibration system 200 shown in FIG. 2 may also, or alternately, be used to detect a loss of calibration associated with the target sensor 102. For example, the target sensor 102 may be initially calibrated via the calibration system 100 shown in FIG. 1, via the self-calibration system 200 shown in FIG. 2, or via any other calibration system or technique. Based on such an initial calibration, the controller 114 may determine that instances of sensor data 112 captured by the calibrated target sensor 102 at different times should indicate the same positions of marker points 128 on the target machine 104.

As a non-limiting example, because the target sensor 102 may be mounted at a fixed position on the target machine 104, the target sensor 102 may be located at fixed distances relative to marker points 128 on the target machine 104, such as left and right front corners of the target machine 104. Accordingly, the same portions or sub-areas of different instances of LiDAR data, image data, or other sensor data 112 captured by the calibrated target sensor 102 over time should depict or represent the marker points 128, unless the target sensor 102 moves or otherwise becomes uncalibrated.

The controller 114 may accordingly use some or all instances of sensor data 112 captured by the target sensor 102 after an initially calibration to determine whether that sensor data 112 indicates positions of marker points 128 on the target machine 104 that are different from previously-determined or expected positions of those marker points 128. If new sensor data 112 captured by the target sensor 102 indicates different positions of one or more marker points 128, relative to positions of those marker points 128 indicated by previous sensor data 112 that was captured based on the initial calibration of the target sensor 102, the controller 114 may determine that the target sensor 102 has become mis-calibrated and/or has lost calibration.

As a non-limiting example, based on an initial calibration of the target sensor 102, the controller 114 may determine that sensor data 112 should show the left and right front corners of the target machine 104 within particular areas of the sensor data 112. For example, if the sensor data 112 is LiDAR point cloud data or an image captured by the target sensor 102, controller 114 may determine that the left and right front corners of the target machine 104 should be represented by the same portions of different instances of captured LiDAR point cloud data, or by the same groups of pixels in different instances of captured image data. However, if at a later time the controller 114 determines that subsequently-captured sensor data 112 shows the left and right front corners of the target machine 104 outside the expected particular areas of the sensor data 112, for instance at areas that are least a threshold distance away from the particular areas of the sensor data 112 that are expected to show the left and right front corners of the target machine 104, the controller 114 may determine that the target sensor 102 has become mis-calibrated and/or has lost calibration.

If the controller 114 detects a calibration issue with the target sensor 102, for instance if new sensor data 112 captured by the target sensor 102 indicates that the target sensor 102 has become mis-calibrated and/or has lost calibration as discussed above, the controller 114 may generate a calibration loss alert. In some examples, the calibration loss alert may be displayed or otherwise presented to an operator of the target machine 104. In other examples, the controller 114 may transmit the calibration loss alert, via wired or wireless communication interfaces, to a remote computing system such as a back office server or cloud computing system, to a controller of another machine, and/or to any other destination.

In some examples, a calibration loss alert generated by the controller 114 may cause the controller 114 to initiate self-calibration operations, for instance to re-calibrate the target sensor 102 via the self-calibration system 200 discussed with respect to FIG. 2. In other examples, the calibration loss alert generated by the controller 114 may trigger calibration of the target sensor 102 via the calibration system 100 discussed above with respect to FIG. 1. For example, when the controller 114 of the target sensor 102 generates a calibration loss alert associated with the target sensor 102, an observing machine 110 may be tasked to use an observing sensor 108 to capture observed sensor data 106 associated with the target sensor 102, such that new calibration data 116 for the target sensor 102 may be generated based on the new observed sensor data 106 as discussed above with respect to FIG. 1. In some examples, the controller 114 may communicate with the observing machine controller 126 of the observing machine 110 to request that the observing machine 110 use its observing sensor 108 to capture new observed sensor data 106 from which new calibration data 116 may be generated. In other examples, the controller 114 may submit such a request or a calibration loss alert to a back office server or other remote computing system, and the remote computing system may assign an observing machine 110 to use an observing sensor 108 to capture new observed sensor data 106 so that new calibration data 116 for the target sensor 102 may be generated. In still other examples, any other type of recalibration process may be performed for the target sensor 102 in response to a calibration loss alert generated by the controller 114.

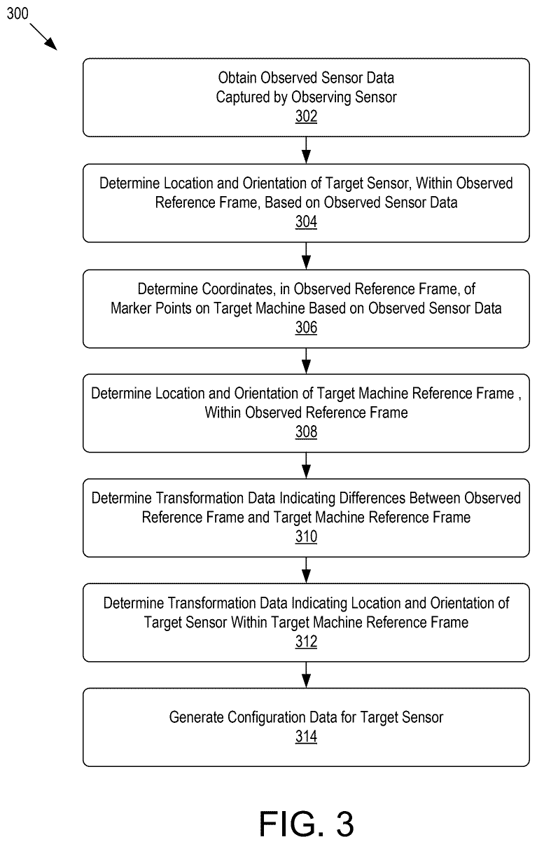

FIG. 3 is a flowchart 300 illustrating an example process for determining calibration data 116 for a target sensor 102 on a target machine 104, based on observed sensor data 106 captured by an observing sensor 108 of an observing machine 110. The operations shown in FIG. 3 may be performed by a computing system, such as the observing machine controller 126 of the observing machine 110, or a remote computing system or other computing system that receives or accesses the observed sensor data 106 captured by the observing sensor 108. FIG. 6, discussed further below, describes an example system architecture for such a computing system.

At block 302, the computing system may obtain observed sensor data 106 captured by the observing sensor 108 of the observing machine 110. The observing machine 110 and/or the observing sensor 108 may be positioned proximate to the target machine 104, such that the observed sensor data 106 reflects information about the target machine 104 and the target sensor 102 of the target machine 104. For example, if the observing sensor 108 is a LiDAR sensor, the observed sensor data 106 may be LiDAR point cloud data indicating locations of points on the target machine 104 and the target sensor 102. The target sensor 102 may be a LiDAR sensor, radar sensor, camera, or any other sensor.

At block 304, the computing system may determine a location and orientation, within the observed reference frame 122, of the target sensor 102 based on the observed sensor data 106. For example, the computing system may use the observed sensor data 106 to identify coordinates, in the observed reference frame 122, of one or more fiducial markers 130 or other points associated with the target sensor 102. The computing system may use the coordinates of such fiducial marker 130 and/or other points to determine a location and/or orientation of the target sensor 102 with respect to the observed reference frame 122.

At block 306, the computing system may determine coordinates, within the observed reference frame 122, of one or more marker points 128 on the target machine 104 based on the observed sensor data 106. The marker points 128 may associated with wheels of the target machine 104, corners of a frame or body of the target machine 104, a work tool of the target machine 104, or any other portions of the target machine 104 that may be indicative of the shape and/or orientation of the target machine 104. For example, the computing system may use the observed sensor data 106 to identify coordinates, in the observed reference frame 122, of one or more fiducial markers 130 or other points associated with the marker points 128 on the target machine 104.

At block 308, the computing system may determine a location and orientation of the target machine reference frame 118, within the observed reference frame 122. For example, if the origin point 124 of the target machine reference frame 118 is defined to be halfway between two back wheels of the target machine 104, the computing system may identify coordinates, in the observed reference frame 122, of the location of a first back wheel of the target machine 104 based on the marker points 128 identified at block 306. The computing system may also use other marker points 128, predefined information about the target machine 104 such as 3D CAD drawings or other schematic information, and/or other information to determine or infer the location of a second back wheel of the target machine 104 relative to the identified location of the first back wheel. Accordingly, the computing system may identify coordinates, in the observed reference frame 122, of the determined or inferred location of the second back wheel of the target machine 104. The computing system may in turn determine coordinates, in the observed reference frame 122, of a point halfway between the coordinates of the first back wheel and the coordinates of the second back wheel. The computing system may use the coordinates of that halfway point as the coordinates, in the observed reference frame 122, of the origin point 124 of the target machine reference frame 118. The computing system may also use marker points 128 and/or other points on the target machine 104, indicated by the observed sensor data 106, to determine the orientation of the target machine 104 and/or the target machine reference frame 118, within the observed reference frame 122, relative to the origin point 124 of the target machine reference frame 118.

At block 310, the computing system may determine transformation data indicating differences between the target machine reference frame 118 and the observed reference frame 122. For example, based on using marker points 128 to determine an orientation of the target machine 104 and the corresponding target machine reference frame 118, the computing system may determine how the observed reference frame 122 associated with the observing sensor 108 is rotated and/or shifted relative to the target machine reference frame 118.

At block 312, the computing system may determine transformation data indicating a location and orientation of the target sensor 102 within the target machine reference frame 118. For example, based on determining locations and orientations of the target sensor 102 and the target machine reference frame 118 in the observed reference frame 122 at blocks 304 and 308, and based on determining the transformation data between the target machine reference frame 118 and the observed reference frame 122 at block 310, the computing system may determine transformation data indicating the location and orientation of the target sensor 102 and/or the sensor reference frame 120 with respect to the target machine reference frame 118. The transformation data generated at block 312 may include translation data including coordinates, in the target machine reference frame 118, of the target sensor 102 and/or an origin point of the sensor reference frame 120, for instance relative to the origin point 124 of the target machine reference frame 118. The transformation data generated at block 312 may also include rotational data, such as roll, pitch, and yaw values, indicating how the target sensor 102 and/or the sensor reference frame 120 is oriented relative to the target machine reference frame 118.

At block 314, the computing system may generate calibration data 116 for the target sensor 102. The calibration data 116 may indicate the transformation data determined at block 312, which as discussed above may indicate the location and orientation of the target sensor 102 with respect to the target machine reference frame 118.

The calibration data 116 generated at block 314 may be transferred to the controller 114 of the target machine 104, for instance via a wired or wireless data connection, via a removable storage device, or other data transfer mechanism. Accordingly, the controller 114 may use the calibration data 116 to interpret sensor data 112 captured by the target sensor 102, for instance to convert sensor data 112 captured based on the sensor reference frame 120 into transformed sensor data based on the target machine reference frame 118. The controller 114 may use the transformed sensor data, expressed based on the target machine reference frame 118, to more accurately determine locations of external objects and features relative to the shape, location, and/or trajectory of the target machine 104.

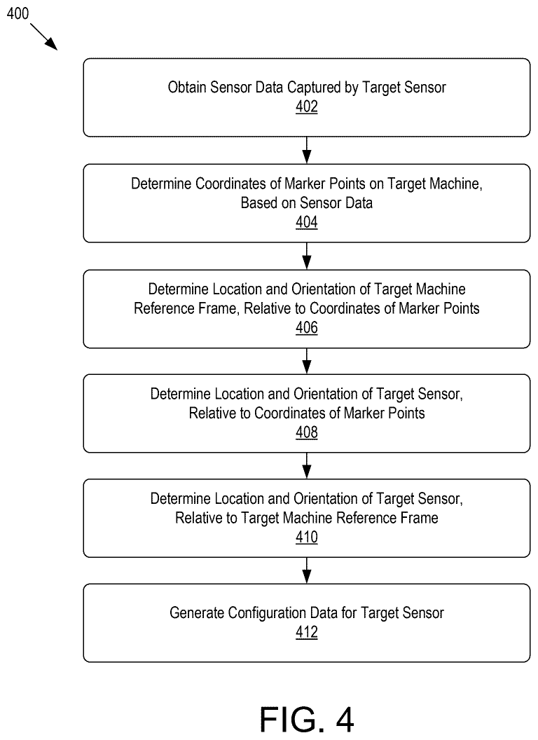

Overall, the process described with respect to FIG. 3 may calibrate the target sensor 102 of the target machine 104 based on observed sensor data 106 captured by the observing sensor 108 of a separate observing machine 110. In some examples, the target sensor 102 may also or alternately be calibrated via self-calibration operations, as discussed further below with respect to FIG. 4.

FIG. 4 is a flowchart 400 illustrating an example process for self-calibrating a target sensor 102 on a target machine 104, based on sensor data 112 captured by the target sensor 102. The operations shown in FIG. 4 may be performed by a computing system, such as the controller 114 of the target machine 104. FIG. 6, discussed further below, describes an example system architecture for such a computing system.

At block 402, the computing system may obtain sensor data 112 captured by the target sensor 102. The target sensor 102 may capture the sensor data 112 based on the sensor reference frame 120. The target sensor 102 may be mounted and/or positioned on the target machine 104 such at least a portion of the sensor data 112 captured by the target sensor 102 shows or depicts elements of at least a portion of the target machine 104, such as portions of a front end of the target machine 104 or any other portions of the target machine 104. As an example, if the target sensor 102 is a LiDAR sensor, the sensor data 112 may be LiDAR point cloud data indicating locations of points on a frond end of the target machine 104 as well as points associated with a surrounding environment beyond the front end of the target machine 104. As another example, if the target sensor 102 is a camera, the sensor data sensor data 112 may be an image that depicts a portion of the front end of the target machine 104 as well as elements within a surrounding environment beyond the front end of the target machine 104.

At block 404, the computing system may determine coordinates of one or more marker points 128 on the target machine 104 based on the observed sensor data 106. The marker points 128 may associated with corners of the front end of the target machine 104, a work tool of the target machine 104, or any other portion of the target machine 104 that may be visible in and/or indicated by the sensor data 112 obtained at block 402. Accordingly, the computing system may use the sensor data 112 to identify coordinates of one or more fiducial markers 130 or other points associated with the marker points 128 on the target machine 104.

At block 406, the computing system may determine the location and orientation of the target machine reference frame 118, relative to the coordinates of the marker points 128. For example, if the origin point 124 of the target machine reference frame 118 is defined to be halfway between two back wheels of the target machine 104, the computing system may use predefined information 202 indicating that the origin point 124 for the target machine reference frame 118 is located at a particular location relative to the coordinates of the marker points 128 identified at block 404. Similarly, the computing system may determine an orientation of the target machine reference frame 118, such as directions of axes of the target machine reference frame 118, based on predefined information 202 indicating the orientation of the target machine reference frame 118 relative to the locations of the marker points 128 identified at block 404. Accordingly, the computing system may use the predefined information 202 to determine or infer the coordinates of the origin point 124 relative to those marker points 128.

At block 408, the computing system may determine a location and orientation of the target sensor 102 and/or the sensor reference frame 120, relative to the coordinates of the marker points 128. For example, the computing system may use the coordinates of marker points 128 determined at block 404 to determine position information 204 indicating the location and orientation of the target sensor 102 and/or the sensor reference frame 120 relative to those marker points 128.

At block 410, the computing system may determine a location and orientation of the target sensor 102 and/or the sensor reference frame 120, relative to the location and orientation of the target machine reference frame 118. For example, based on determining locations and orientations of the target machine reference frame 118 and the target sensor 102 or the sensor reference frame 120 relative to the locations of the marker points 128 at blocks 406 and 408, the computing system may determine a transform indicating a location and orientation of the target sensor 102 or the sensor reference frame 120 relative to the target machine reference frame 118.

At block 412, the computing system may generate calibration data 116 for the target sensor 102. The calibration data 116 may indicate the transform determined at block 410, which indicates a location and orientation of the target sensor 102 and/or the sensor reference frame 120 relative to the target machine reference frame 118. The computing system may use the calibration data 116 to interpret subsequent sensor data 112 captured by the target sensor 102. For instance, the computing system, such as the controller 114, may use the calibration data 116 to convert sensor data 112 captured based on the sensor reference frame 120 into transformed sensor data based on the target machine reference frame 118. The computing system may use the transformed sensor data, expressed based on the target machine reference frame 118, to more accurately determine locations of external objects and features relative to the shape, location, and/or trajectory of the target machine 104.

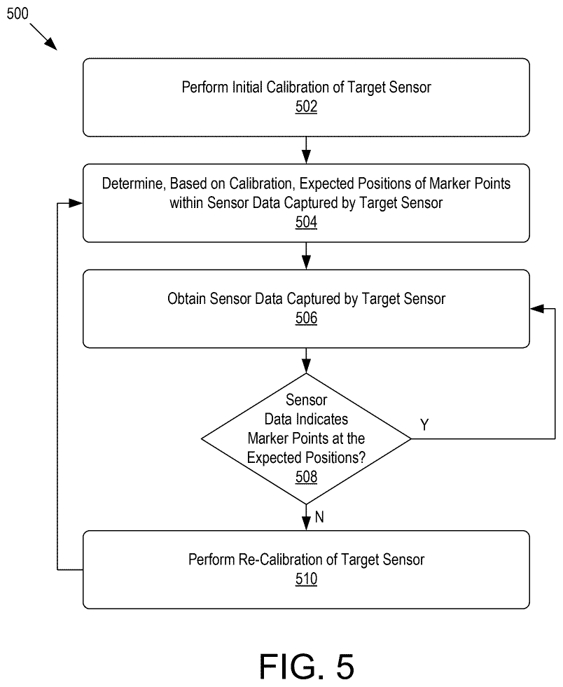

Overall, the process described with respect to FIG. 3 may allow the target sensor 102 to be self-calibrated, instead of or in addition to calibration of the target sensor 102 based on observed sensor data 106 captured by the observing sensor 108 of a separate observing machine 110 as discussed above with respect to FIG. 2. After the target sensor 102 is calibrated using either or both of the processes shown in FIG. 2 and FIG. 3, a computing system may monitor for a loss of calibration of the target sensor 102 as discussed further below with respect to FIG. 5.

FIG. 5 is a flowchart 500 illustrating an example process for detecting a loss of calibration of a target sensor 102 on a target machine 104, based on sensor data 112 captured by the target sensor 102. The operations shown in FIG. 5 may be performed by a computing system, such as the controller 114 of the target machine 104. FIG. 6, discussed further below, describes an example system architecture for such a computing system.

At block 502, an initial calibration of the target sensor 102 may be performed. In some examples, the target sensor 102 may be calibrated based on observed sensor data 106 captured by the observing sensor 108 of a separate observing machine 110, as discussed above with respect to FIG. 2. In other examples, the target sensor 102 may be self-calibrated based on sensor data 112 captured by the target sensor 102, as discussed above with respect to FIG. 3. In still other examples, the target sensor 102 may be calibrated via any other calibration technique.

At block 504, the computing system may determine, based on the calibration of the target sensor 102, expected positions of marker points 128 within sensor data 112 captured by the target sensor 102. As an example, if the marker points 128 are front corners of the target machine 104, the computing system can determine expected positions where the front corners of the target machine 104 should appear within sensor data 112 captured by the calibrated target sensor 102. For instance, if the sensor data 112 is LiDAR point cloud data or an image captured by the target sensor 102, the computing system may use sensor data 112 captured after the calibration to determine portions of the LiDAR point cloud data or groups of pixels of the image that depict the front corners of the target machine 104, and thereby determine that the front corners of the target machine 104 should continue to appear at the same portions or pixels of future sensor data 112 captured by the target sensor 102.

At block 506, the computing system may obtain new sensor data 112 captured by the target sensor 102 after the calibration. For example, the computing system may obtain new LiDAR data, image data, or another type of sensor data 112 captured by the target sensor 102.

At block 508, the computing system may determine whether the new sensor data 112 obtained at block 506 indicates marker points 128 at the expected positions determined at block 504. For example, particular areas of instances of LiDAR data or particular groups of pixels in image data may be expected positions at which front corners of the target machine 104 or other marker points 128 on the target machine 104 should appear. Accordingly, the computing system may determine whether marker points 128 appear in the new sensor data 112 at or near the expected positions determined, for instance within a threshold distance of the expected positions. If the marker points 128 are at the expected positions in the new sensor data 112, or are present at other locations within a threshold distance from the expected positions, (Block 508—Yes), the computing system may determine that the target machine 104 is still calibrated, and may return to block 506 to obtain additional new sensor data 112 captured by the target sensor 102.

However, if the new sensor data 112 does not show marker points 128 at the expected positions, for instance if the sensor data 112 does not show the marker points 128 and/or shows the marker points 128 at portions of the sensor data 112 that are separated from the expected positions by at least at threshold distance, (Block 508—No), the computing system may determine that the target machine 104 is mis-calibrated or is experiencing a loss of calibration, and re-calibration of the target sensor 102 may be performed at block 510.

For example, at block 510 the computing system may generate and/or output a calibration loss alert that may instruct the computing system, a different computing system, a user, or another entity to re-calibrate the target sensor 102. In some examples, the target sensor 102 may be re-calibrated based on observed sensor data 106 captured by the observing sensor 108 of a separate observing machine 110, based on the process discussed above with respect to FIG. 2. In other examples, the target sensor 102 may be re-calibrated via self-calibration operations using sensor data 112 captured by the target sensor 102, based on the process discussed above with respect to FIG. 3. In still other examples, the target sensor 102 may be re-calibrated via any other calibration technique.

FIG. 6 shows an example system architecture for a computing system 600 that executes one or more elements described in the present disclosure. The computing system 600 may include one or more computing devices, controllers, servers, or other computing elements that include one or more processors 602, memory 604, and/or communication interfaces 606.

In some examples, the computing system 600 may be the controller 114 of the target machine 104. In these examples, the controller 114 may use calibration data 116 associated with the target sensor 102 to interpret sensor data 112 captured by the target sensor 102. In various examples, the controller 114 may also, or alternately, generate new calibration data 116, receive calibration data 116 generated by a different computing system, detect a loss of calibration associated with the target sensor 102, and/or perform other operations described herein.

In other examples, the computing system 600 may be a different computing system, such as the observing machine controller 126 of the observing machine 110, or a remote computing system such as a server, cloud computing system, or other computing element that may be separate from the target machine 104. In these examples, the computing system 600 may process observed sensor data 106 captured by an observing sensor 108 to generate new calibration data 116 for the target sensor 102, provide the calibration data 116 to the controller 114 of the target machine 104, and/or perform other operations described herein.

In some examples, elements of the systems described herein may be distributed among multiple computing systems similar to the computing system 600 shown in FIG. 6. As an example, the observing machine controller 126 may be a first computing system that generates calibration data 116 for the target sensor 102, while the controller 114 may be a second computing system that uses the calibration data 116 generated by the first computing system to interpret sensor data 112 captured by the target sensor 102.

The processor(s) 602 of the computing system 600 may operate to perform a variety of functions as set forth herein. The processor(s) 602 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art.

In some examples, the processor(s) 602 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 602 may also access content and computer-executable instructions stored in the memory 604, and execute such computer-executable instructions.

The memory 604 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 602 to perform the operations described herein.

For example, the memory 604 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 602 and/or communication interface(s) 606 during execution thereof by the computing system 600. For example, the processor(s) 602 may possess local memory, which also may store program modules, program data, and/or one or more operating systems.

The memory 604 may store data and/or computer-executable instructions associated with elements of the systems described herein. For example, the memory 604 may store data and/or computer-executable instructions associated with the calibration data 116, a sensor data analyzer 608, a calibration data generator 610, a calibration loss detector 612, and/or other elements. As discussed above, the calibration data 116 may indicate a transformation between the target machine reference frame 118 and the sensor reference frame 120 of the target sensor 102. The sensor data analyzer 608 may be used by the controller 114 to interpret sensor data 112 captured by the target sensor 102, based at least in part on the calibration data 116. The calibration data generator 610 may be used by the controller 114 to generate new calibration data 116 for the target sensor 102, for instance based on observed sensor data 106 captured by a different observing sensor 108 or based on sensor data 112 captured by the target sensor 102. The calibration loss detector 612 may be used by the controller 114 to determine if and/or when the target sensor 102 becomes mis-calibrated or loses calibration after an initial calibration, and/or to generate a corresponding calibration loss alert, as discussed above.

The memory 604 may also store other modules and data 614 that may be utilized by the computing system 600 to perform or enable performing any action taken by the computing system 600. For example, the other modules and data 614 may include a platform, operating system, and/or applications, as well as data utilized by the platform, operating system, and/or applications.

The communication interfaces 606 may include transceivers, modems, interfaces, antennas, and/or other components that may transmit and/or receive data over networks or other data connections via wired and/or wireless connections. For example, if the computing system 600 is the controller 114, the communication interfaces 606 may allow the controller 114 to receive calibration data 116 generated by a different computing system, to provide a calibration loss alert to a different computing system, and/or otherwise communicate with one or more other computing systems. Similarly, if the computing system 600 is the observing machine controller 126 or a remote computing system that generates the calibration data 116, the communication interfaces 606 may allow the computing system 600 to provide the generated calibration data 116 to the controller 114 of the target machine 104.

### INDUSTRIAL APPLICABILITY

As described herein, a target sensor 102 on a target machine 104 may be calibrated based on observed sensor data 106 captured by an observing sensor 108 of a separate observing machine 110, and/or based on sensor data 112 captured by the target sensor 102 itself. A controller 114 of the target machine 104 may also be configured to detect a loss of calibration of the target sensor 102, based on sensor data 112 captured by the target sensor 102.

The calibration systems described herein may allow the target sensor 102 to be calibrated more quickly and/or more efficiently than other types of calibration techniques. For example, rather than manually setting up specialized external calibration objects at designated locations on a worksite, and determining whether captured sensor data accurately indicates the designated locations of the external calibration objects, the calibration systems described herein may calibrate the target sensor 102 without the use of extra equipment or specialized external calibration objects.

For example, multiple machines operating at a worksite may have LiDAR sensors or other sensors that capture corresponding sensor data used to direct some or all operations of the respective machines. Because two machines present at the worksite may already have distinct sensors, one of the machines may serve as the observing machine 110 and the other machine may serve as the target machine 104. Accordingly, an existing sensor of the machine designated as the observing machine 110 may be used as the observing sensor 108, in order to capture observed sensor data 106 that can be used to generate calibration data 116 for an existing sensor of the other machine designated as the target machine 104. The machines can also swap roles, such that existing sensors on the machines may be used to calibrate existing sensors of other machines. Accordingly, sensors of the machines may be calibrated without the use of separate external calibration equipment, manual time or effort involved in sensor calibration, and/or other issues. For instance, although the machines may be configured to use existing sensors for other purposes on the worksite, the machines may also use those existing sensors to calibrate sensors of other machines while the machines are traveling and/or performing other work at the worksite, and/or at times when the machines are assigned to assist with sensor calibration.

As another example, because the controller 114 of the target machine 104 may use sensor data 112 captured by the target sensor 102 to perform self-calibration operations for the target sensor 102, and/or to detect a loss of calibration of the target sensor 102, such operations can be performed without setting up or using extra calibration equipment or markers that are separate from the target machine 104. For instance, the controller 114 can self-calibrate the target sensor 102, and/or detect a loss of calibration of the target sensor 102, based on detection of marker points 128 on the target machine 104 shown in sensor data 112 captured by the target sensor 102. The controller 114 can accordingly self-calibrate the target sensor 102, and/or detect a loss of calibration of the target sensor 102, without detecting separate calibration markers or patterns that have been set up within a surrounding environment away from the target machine 104.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A method, executed by a computing system comprising a processor, comprising:
obtaining observed sensor data captured by an observing sensor of an observing machine, wherein:
the observing machine is different from a target machine,
the observing sensor is different from a target sensor of the target machine, and
the observed sensor data is captured based on an observed reference frame;
determining first coordinates, in the observed reference frame, of the target sensor based on the observed sensor data;
determining second coordinates, in the observed reference frame, of an origin point of a target machine reference frame associated with the target machine;
determining a difference between the observed reference frame and the target machine reference frame;
determining a transformation based on the first coordinates, the second coordinates, and the difference, the transformation indicating third coordinates of the target sensor in the target machine reference frame; and
generating calibration data, for the target sensor, indicating the transformation.

2. The method of claim 1, further comprising:
determining, based on the observed sensor data, a first orientation of the target sensor in the observed reference frame; and
determining, a first rotational difference between the first orientation of the target sensor in the observed reference frame and a second orientation of the target machine reference frame,
wherein the transformation further indicates a second rotational difference between the second orientation of the target machine reference frame and a third orientation of the target sensor in the target machine reference frame.

3. The method of claim 1, wherein the observing sensor is a Light Detection and Ranging (LiDAR) sensor, and the observed sensor data is LiDAR point cloud data.

4. The method of claim 3, wherein determining the first coordinates of the target sensor is based on identifying, within the LiDAR point cloud data, locations of at least one of:
one or more fiducial markers on the target sensor, or
one or more points of the LiDAR point cloud data associated with the target sensor.

5. The method of claim 3, wherein determining the second coordinates of the origin point comprises:
identifying, based on the LiDAR point cloud data, locations of one or more features of the target machine; and
determining, based on the locations of the one or more features and predefined information about the target machine, the second coordinates of the origin point.

6. The method of claim 5, wherein:
the one or more features are associated with a first back wheel of the target machine,
the origin point is defined to be at a particular location midway between the first back wheel and a second back wheel of the target machine, and
the method comprises inferring a location of the second back wheel, relative to the first back wheel, based on at least one of the predefined information about the target machine or an orientation of the target machine indicated by the LiDAR point cloud data.

7. The method of claim 1, further comprising transferring the calibration data to a controller of the target machine, wherein the controller is configured to use the calibration data to interpret sensor data captured by the target sensor.

8. The method of claim 1, wherein the target sensor is a Light Detection and Ranging (LiDAR) sensor, a radar sensor, or a camera.

9. A system comprising:
a target machine comprising a first controller and a target sensor; and
an observing machine comprising a second controller and an observing sensor, wherein the second controller is configured to:
obtain observed sensor data captured by the observing sensor based on an observed reference frame;
determine, based on the observed sensor data, a first location and a first orientation of the target sensor within the observed reference frame;
determine, based on the observed sensor data, a second location and a second orientation, within the observed reference frame, of a target machine reference frame associated with the target machine;
determine differences between the observed reference frame and the target machine reference frame;
determine, based on the differences and the first location, the first orientation, the second location, and the second orientation within the observed reference frame, transformation data indicating a third location and a third orientation of the target sensor within the target machine reference frame; and
generate calibration data, for the target sensor, indicating the transformation data,
wherein the first controller is configured to use the calibration data to interpret sensor data captured by the target sensor.

10. The system of claim 9, wherein the observing sensor is a Light Detection and Ranging (LiDAR) sensor, and the observed sensor data is LiDAR point cloud data.

11. The system of claim 10, wherein the second controller determines the first location and the first orientation of the target sensor, within the observed reference frame, based on identifying, within the LiDAR point cloud data, locations of at least one of:
one or more fiducial markers on the target sensor, or
one or more points of the LiDAR point cloud data associated with the target sensor.

12. The system of claim 10, wherein the second controller determines the second location and the second orientation of the target machine reference frame, within the observed reference frame, based at least in part on identifying, using the LiDAR point cloud data, locations of one or more features on the target machine.

13. The system of claim 12, wherein:
the one or more features are associated with a first component of the target machine,
an origin point of the target machine reference frame is defined, by predefined information about the target machine, to be at a particular location midway between the first component and a second component of the target machine, and
the second controller infers a location of the second component, relative to the first component, based on at least one of the predefined information or an orientation of the target machine indicated by the LiDAR point cloud data.

14. The system of claim 9, wherein the target sensor is a Light Detection and Ranging (LiDAR) sensor, a radar sensor, or a camera.

15. A controller of a machine, comprising:
one or more processors; and
memory storing computer-executable instructions that, when executed by the one or more processors, cause the one or more processors to perform operations comprising:
obtaining sensor data captured by a sensor of the machine based on a sensor reference frame;
determining, based on the sensor data, locations of one or more marker points on the machine;
determining, based on the sensor data, a first location and a first orientation of a machine reference frame associated with the machine, relative to the locations of the one or more marker points;
determining, based on the sensor data, a second location and a second orientation of the sensor, relative to the locations of the one or more marker points;
determining, based on the first location, the first orientation, the second location, and the second orientation relative to the locations of the one or more marker points, transformation data indicating a third location and a third orientation of the sensor within the machine reference frame; and
generating calibration data, for the sensor, indicating the transformation data.

16. The controller of claim 15, wherein the sensor is a Light Detection and Ranging (LiDAR) sensor or a camera.

17. The controller of claim 15, wherein the one or more marker points are points on an exterior of the machine that are depicted in the sensor data captured by the sensor.

18. The controller of claim 15, wherein the computer-executable instructions cause the one or more processors to use the calibration data to interpret subsequent sensor data captured by the sensor.

19. The controller of claim 15, wherein the computer-executable instructions cause the one or more processors to determine, based on the calibration data, expected positions of the one or more marker points within instances of the sensor data captured by the sensor.

20. The controller of claim 19, wherein the computer-executable instructions cause the one or more processors to:
obtain subsequent sensor data captured by the sensor;
determine positions of the one or more marker points within the subsequent sensor data;
determine that the positions of the one or more marker points within the subsequent sensor data are located at least a threshold distance away from the expected positions; and
generate a calibration loss alert, associated with the sensor, based on determining that the positions are at least the threshold distance away from the expected positions.
